(19) United States
(12) Patent Application Publication
(10) Pub. No.: US 2021/0224828 A1
(43) Pub. Date: Jul. 22, 2021

(54) REAL-TIME DYNAMIC MONITORING OF SENTIMENT TRENDS AND MITIGATION OF THE SAME IN A LIVE SETTING

(71) Applicant: Bank of America Corporation, Charlotte, NC (US)

(72) Inventors: Michael Ogrinz, Easton, CT (US); Maria Carolina Barraza Enciso, New York, NY (US); Daniel J. Serna, The Colony, TX (US); Elena Kvochko, New York, NY (US)

(21) Appl. No.: 16/745,673

(22) Filed: Jan. 17, 2020

(51) Int. Cl. G06Q 30/02; G16Y 20/40; G16Y 40/20; G16Y 10/45

(52) U.S. Cl. CPC G06Q 30/0201; G06Q 30/0281; G16Y 10/45; G16Y 40/20; G16Y 20/40

(57) ABSTRACT

A method for identifying and mitigating a negative sentiment trend derived from sentiment analysis is provided. The analysis is based on aggregating a plurality of biometric information artifacts obtained from consumers in a consumer center. The method includes harvesting the artifacts from the plurality of consumers, identifying a biometric information trend. The biometric trend includes a verbal communications trend recorded from among the plurality of consumers. The verbal communications are captured using microphone(s). The method may also include periodically updating the harvesting to update the biometric information trend. The method may also include determining, over the pre-determined amount of time, that the biometric information trend is a negative biometric information trend. In response to the determining the method may trigger, based at least in part on a slope of the negative biometric information trend, a mitigating response to the negative biometric information trend.

### FIELD OF TECHNOLOGY

This disclosure relates to sentiment analysis.

### BACKGROUND OF THE DISCLOSURE

Individuals who frequent a location such as a consumer center may generate comprehensible sentiment in the location. Such sentiment may be generated in the form of biometric signals. At least some of the biometric signals may include some level of sentiment expression. Sentiment may be expressed in the form of verbal statements. Sentiment may be in the form of electronic signals. Generated sentiment may be harvested and stored as non-user identifiable information. Shifts in the sentiment from positive to negative, and from negative to positive, may be analyzed to help mitigate the effects of such shifts and/or to augment the benefits coincident with such shifts.

It would be desirable to analyze the sentiment of public data to provide predictive indicators of physical threats, damaging and/or negative future occurrences.

It would be further desirable to analyze the sentiment of public data to detect and remediate projected difficulties or ease.

It would be still further desirable to pull public data in one or more locations from a variety of sensors (such as Internet of Things (“IoT”) sensors), microphones, and/or other devices positioned in the location(s) that are suitable for recording biometric information from individuals in the location(s).

### SUMMARY OF THE DISCLOSURE

A method for identifying and mitigating a negative sentiment trend is provided. The sentiment trend is typically derived from a sentiment analysis. The sentiment analysis may be based on aggregating a plurality of biometric information artifacts obtained from a gathering of a plurality of consumers in a location. The location may be a consumer center. The consumer center may be located in a confined space. The consumer center may be an area within an open space.

The method may include harvesting the artifacts from the plurality of consumers, and, based on the harvesting, identifying a biometric information trend among the plurality of consumers. The biometric information trend may include a physical movement trend detected from among the plurality of consumers.

The harvesting may further include capturing the biometric information using one or more thermal cameras. The thermal cameras may determine a plurality of physical movements of the plurality of consumers. The method may also include periodically updating, over a pre-determined amount of time, the harvesting. The periodically updating may be used to update the biometric information.

The method may also include determining, over the pre-determined amount of time, that the biometric information trend is a negative biometric information trend. Upon such a determination the method may trigger, based at least in part on a slope of the negative biometric information trend, a mitigating response to the negative biometric information trend.

The mitigating response may be selected from a group consisting of one or more e-mail communications to a selected group of consumers associated with an entity controlling the consumer center; one or more electronic text messaging communications to the selected group of consumers associated with the entity; one or more electronically-generated telephone communications to the selected group of consumers associated with the entity; one or more electronically-generated chat communications to the selected group of consumers associated with the entity. The mitigating response may include some or all of the aforementioned mitigating responses.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustratively equipped consumer center in accordance with principles of the disclosure;

FIG. 2 shows an illustrative diagram in accordance with principles of the disclosure;

FIG. 3 shows another illustrative diagram in accordance with principles of the disclosure;

FIG. 4 shows yet another illustrative diagram in accordance with principles of the disclosure;

FIG. 5 shows still another illustrative diagram in accordance with principles of the disclosure;

FIG. 6 shows yet another illustrative diagram in accordance with principles of the disclosure;

FIG. 7 shows still another illustrative diagram in accordance with principles of the disclosure;

FIG. 8 shows yet another illustrative diagram in accordance with principles of the disclosure;

FIG. 9 shows an illustrative flow diagram in accordance with principles of the disclosure; and

FIG. 10 shows another illustrative flow diagram in accordance with principles of the disclosure.

### DETAILED DESCRIPTION OF THE DISCLOSURE

A method for identifying and mitigating a sentiment trend is provided. The sentiment trend may be a negative sentiment trend. The sentiment trend may be a positive sentiment trend. The sentiment trend may be a sentiment trend from positive to negative. The sentiment trend may be a sentiment trend from negative to positive.

The sentiment trend may be derived from a sentiment analysis. The sentiment analysis may be based on aggregating a plurality of biometric information artifacts obtained from a gathering of a plurality of consumers in a consumer center. Biometric information artifacts may be referred to alternately herein as “artifacts” or “biometric information.” The aggregating may include harvesting. The method may include harvesting the artifacts from the plurality of consumers. The artifacts may be non-consumer identifiable information, such as mathematical values, words/phrases, or other data as described below.

The consumer center may be located in a confined space. The consumer center may be an area within an open space. The consumer center may be a location from which the artifacts are obtained. The consumer center may be one, two, three or more areas from which the artifacts are obtained.

The method may further include identifying a biometric information trend based on the harvesting. The artifacts may include a plurality of body temperatures recorded from among the plurality of consumers. The biometric information trend may include a body temperature trend recorded from among the plurality of consumers.

The artifacts may include a plurality of heart rates recorded from among the plurality of consumers. The biometric information trend may include a heart rate trend recorded from among the plurality of consumers. The methods may include using a thermal camera to harvest the plurality of heart rates.

The artifacts may include a plurality of blood pressures recorded from among the plurality of consumers. The biometric information trend may include a blood pressure trend recorded from among the plurality of consumers. The methods may include using a thermal camera to harvest the plurality of heart rates.

The harvesting may capture the biometric information using one or more thermal cameras to determine the body temperature for each of the plurality of consumers. The thermal camera may be a heat sensor. The method may further include periodically updating, over a pre-determined amount of time, the determining the body temperature of the plurality of consumers, which may, in turn, be used to update the biometric information trend.

The harvesting may include capturing an information trend using one or more microphones to record a set of verbal communications. The method may include harvesting the artifacts from the plurality of consumers, the artifacts comprising a set of verbal communications. Based on the harvesting, the methods may include identifying an information trend. The methods may include periodically updating, over a pre-determined amount of time, the harvesting, said periodically updating used to update the information trend.

The harvesting may include capturing biometric information using one or more thermal cameras. The thermal cameras may be used to determine a plurality of physical movements of the plurality of consumers. The method may include harvesting the artifacts from the plurality of consumers, and, based on the harvesting, identifying a biometric information trend among the plurality of consumers. The biometric information trend may include a physical movement trend detected from among the plurality of consumers.

The harvesting may include using one or more thermal cameras, heat sensors, microphones, IoT devices or other suitable apparatus to detect some or all of the body temperature, the heart rate, the blood pressure, the verbal communications and the plurality of movements.

Information harvested may be stored in one or more databases. The databases may store the harvested information as non-user identifiable information. The non-user identifiable information may not associate the stored data with an identity of an individual. For example, when body temperature is measured in the consumer location, the measured values may be stored and associated with a timestamp. Negative tends may be increasing body temperature values over a time period, such as between 5 measurements taken at 2-minute intervals.

Heart rate and blood pressure may be also be measured, at the same time or at different times, and the measured values may be associated with a timestamp, identifying a time at which the measurement(s) were taken, and not with any personally identifiable information. Negative trends may be increasing heart rate over a time period. Negative trends may be increasing blood pressure over a time period.

Verbal communications may be recorded using one or more speakerphones and stored in a database. Communications recorded may be associated with a timestamp identifying a time at which the communication(s) were recorded. The recorded communications may be parsed to identify words and/or phrases included in the communications. The identified words/phrases may then be analyzed to retrieve any words/phrases associated with positive or negative sentiment. Sentiment analysis described herein may be used to determine if the words/phrases should be associated with positive or negative sentiment. Negative trends may be an increasing number of negative sentiment words/phrases over a time period.

It is to be understood that a positive trend may be an opposite of a negative trend detailed above.

Thus, information harvested may include mathematical values (body temperature, heart rate, blood pressure, etc.) and/or, words/phrases, with no personally identifiable information. This may ensure privacy of consumers in the consumer location.

To the extent that it may be necessary to capture personally identifying information, this should be done only in circumstances of clear and present danger and preferably upon receipt of consent of relevant individuals involved.

In some embodiments, the consumer location may be a location at which the consumer may potentially be in danger, such as at a device from which cash can be retrieved. In some of these embodiments, the methods may include harvesting information for the individual standing in front of the payment device. The consumer may have the opportunity to opt-in to having his harvested information associated with his identity, so that remedial action can be taken to protect him if he is determined to be in a dangerous situation.

The method may also include periodically updating, over a pre-determined amount of time, the harvesting. The periodically updating may be used to update the biometric information.

The method may also include determining, over the pre-determined amount of time, that the biometric information trend is a negative biometric information trend. The methods may include triggering a mitigating response to the negative biometric information trend. The triggering may be based at least in part on a slope of the negative biometric information trend.

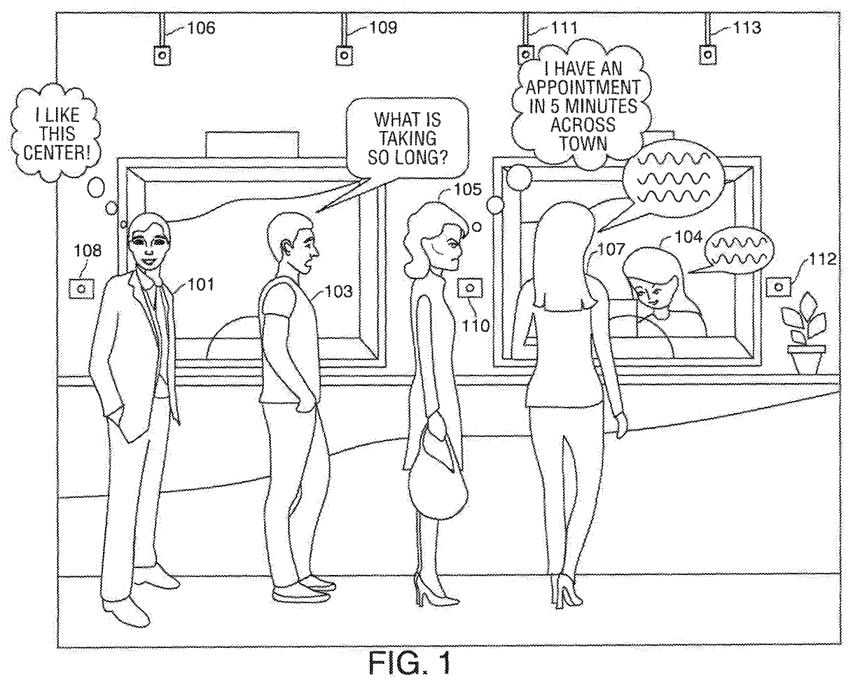

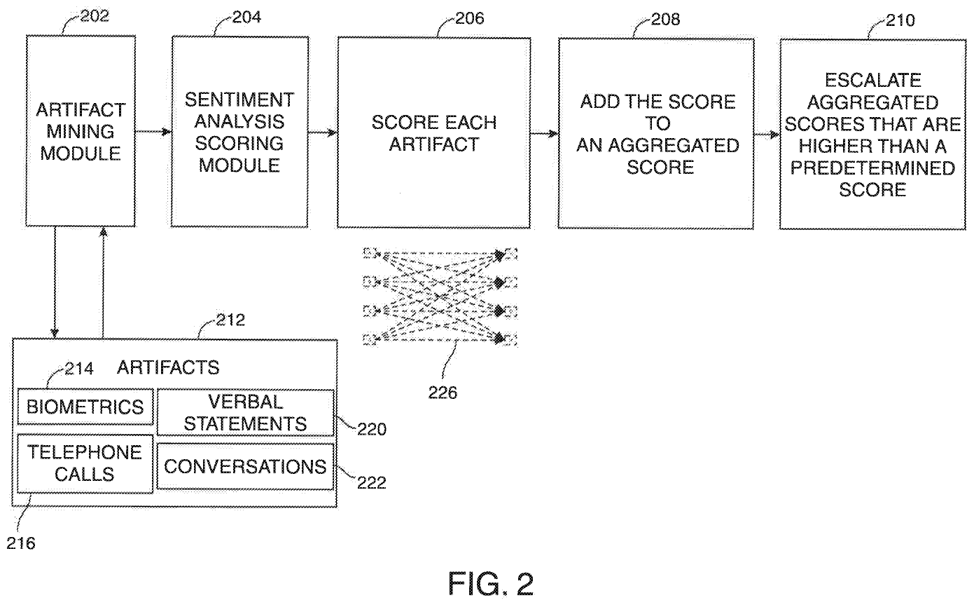

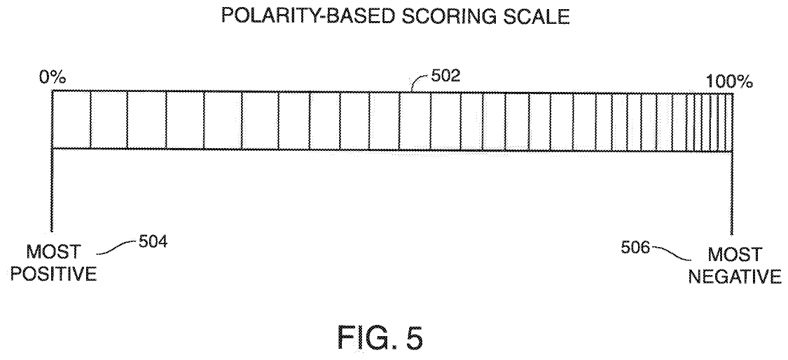

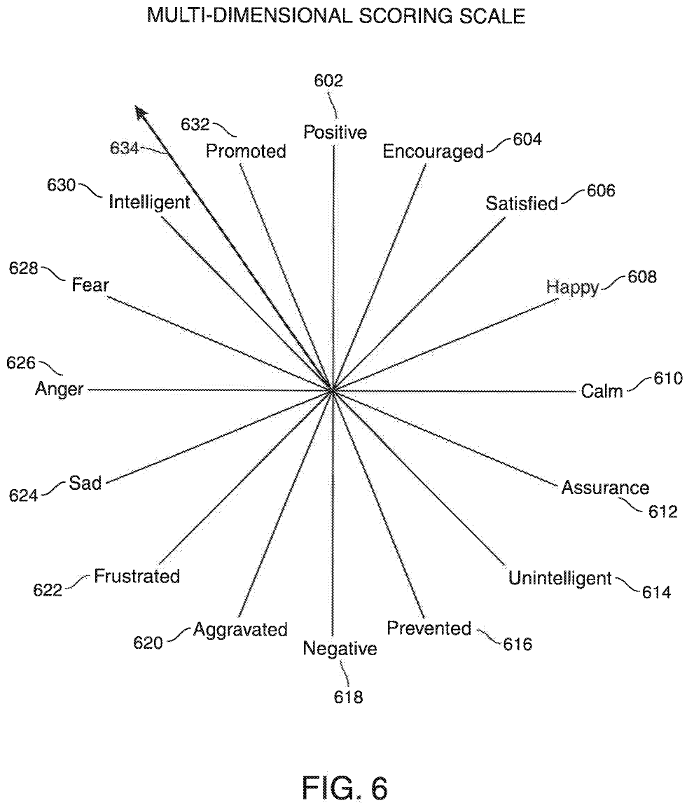

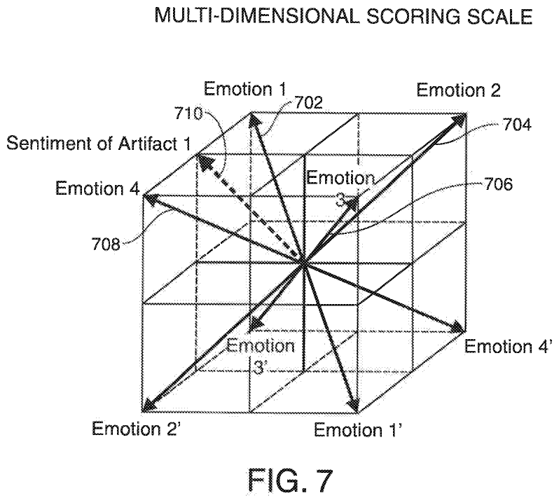

The negative biometric information trend may be determined using artifact mining, scoring and processing illustrated in FIG. 2. A scoring scale use to identify the negative biometric trend may include the scoring scale illustrated in FIG. 5, the multi-dimensional scoring scale illustrated in FIG. 6, and/or the multi-dimensional scoring scale illustrated in FIG. 7. Additional methods described in FIGS. 1, 3-4 and 8-10 may be used to obtain and process the artifacts harvested using the methods described herein.

A negative biometric information trend may be associated with an increase or decrease of an artifact, such that the increase or decrease reflects at least one negative sentiment of one or more consumers in the consumer center.

An increase in body heat may be a negative biometric information trend.

A decrease in physical movement in the consumer center may be a negative biometric information trend.

The detection of an increase in negative verbal words or phrases may be a negative biometric information trend.

A negative biometric information trend may be associated with a detection of a predetermined number of artifacts during a time period, such that the detected predetermined number of artifacts reflects at least one negative sentiment of one or more consumers in the consumer center.

A detection of body heat for one or more individuals that is over a threshold value may be a negative biometric information trend.

A detection of a value associated with a physical movement of one or more individuals that is above a threshold value of physical movement may be a negative biometric information trend.

A detection of a threshold number of negative verbal words of phrases may be a negative biometric information trend. A detection of a threshold number of negative verbal words of phrases during a predetermined time period may be a negative biometric information trend.

The mitigating response may be selected from a group consisting of one or more e-mail communications to a selected group of consumers associated with an entity controlling the consumer center, one or more electronic text messaging communications to the selected group of consumers associated with the entity, one or more electronically-generated telephone communications to the selected group of consumers associated with the entity, one or more electronically-generated chat communications to the selected group of consumers associated with the entity and/or a combination of one or more of the foregoing.

The mitigating response may be triggered in real-time following the determining of the negative biometric information trend. It should be noted that the mechanism for selection of consumers to whom the response is sent may be based on the geo-location of the consumers. For example, if the entity associated with the consumer center detected a negative sentiment trend at the consumer center, it could select a number of consumers within a pre-determined distance of the consumer center—provided that the entity possessed some form of electronic communication access with the consumers, which may include a knowledge of the consumers' geo-spatial coordinates. By mapping the coordinates of the consumer center against its consumer base, the entity could send a mitigating response to a negative sentiment trend to all consumers within the pre-determined distance of the consumer center. Such a mapping and mitigating could preferably be performed independent of knowledge of the consumers to whom the mitigating response was sent. This is because the consumers may have been selected only by their respective locations and not their identity. Alternatively, such a selection could be performed by sending to all consumers that are based in certain zip code or to consumers identified by some other geographic identifier.

In certain embodiments, the harvesting may include using a thermal camera to identify physical movements associated with the plurality of consumers.

In some embodiments, the harvesting may further include retrieving verbal communications from the plurality of consumers, and parsing, using natural language processing and computational linguistics, the retrieved verbal communications to contribute to the harvesting.

The harvesting the biometric information trend may include harvesting while maintaining anonymous the identities of each of the plurality of the consumers.

In some embodiments, the harvesting the biometric information may also include using the thermal camera to identify facial expressions associated with the plurality of consumers.

The method may also include determining, over the pre-determined amount of time, that the biometric information trend is a positive biometric information trend. The method may also include determining that the biometric information trend is trending from positive to negative. The method may also include determining that the biometric information trend is trending from negative to positive. The aforementioned biometric information trends may be determined using artifact mining, scoring and processing illustrated in FIG. 2. A scoring scale use to identify the aforementioned biometric trend may include the scoring scale illustrated in FIG. 5, the multi-dimensional scoring scale illustrated in FIG. 6, and/or the multi-dimensional scoring scale illustrated in FIG. 7.

FIG. 1 shows an exemplary consumer center 100 according to certain embodiments. Center 100 is may be equipped with one or more microphones 106, 109, 111 and 113. Center 100 is may be equipped with one or more of smart sensors 108, 110 and 112.

Microphones 106, 109, 111 and 113 may be configured to receive, store and/or transmit sounds generated in center 100. Smart sensors 108, 110 and 112 may be configured to receive, store and/or transmit sounds. Smart sensors 108, 110 and 112 may also be configured to receive, store and/or transmit video footage. Under certain circumstances, smart sensors 108, 110 and 112 may be configured to receive, store and/or transmit only non-personally-identifying video footage. In certain embodiments, microphones 106, 109, 111 and 113 and/or smart sensors 108, 110 and 112 may include wireless communication capabilities.

Smart sensors 108, 110 and 112 may include devices that detect changes in a physical or virtual operating environment. Such changes may define an attribute of the environment. For example, sensors may measure attributes such as human body temperature, physical movements, etc. Sensors 108, 110 and 112 may measure electronic network traffic, electronic signals (e.g., input or output) or frequency of user logins within a predefined area. Sensors 108, 110 and 112 may be deployed throughout center 100.

In certain embodiments, sensors 108, 110 and 112 may implement two or more functions. For example, sensors 108, 110 and 112 may measure changes in their physical or virtual environment, capture data corresponding to the measured changes and store/communicate the captured data.

Each of sensors 108, 110 and 112 may be a sensor and each of sensors 108, 110 and 112 may be assigned a unique identifier. For example, sensors may be identified by one or more radio frequency identification (“RFID”) tags. The RFID tag may be stimulated to transmit identity information about the sensor or any other information stored on the RFID tag. Sensors may be identified by an Internet Protocol (“IP”) address.

Data captured by sensors 108, 110 and 112 may be transmitted by the sensor and processed at a different location. The location could be substantially co-located—i.e., in the same center 100—with the sensor or far from the location where the data was captured. For example, captured data may be transmitted from one sensor to another sensor until the captured data reaches a data repository.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

In FIG. 1, data that may be retrieved for sentiment analysis may include the pleasant facial expression of consumer 101. This artifact may be considered a positive artifact.

Also, in FIG. 1, data that may be retrieved for sentiment analysis may include the verbal statement made be consumer 103. Consumer 103 states, “[w]hat is taking so long.” This may be considered a negative sentiment statement. Such a statement is preferably retrieved by one or more of microphones 106, 109, 111, and/or 113.

The cross facial expression of consumer 105 may also be retrieved, although her thought, “I have an appointment in five (5) minutes across town,” may not. Such a cross facial expression may be retrieved and recorded as a negative sentiment indicator. Such a negative sentiment may be retrieved by one or more of sensors 108, 110 and/or 112.

Consumer 107 and consumer care representative 104 may be engaging in a conversation that indicates neither positive nor negative sentiment.

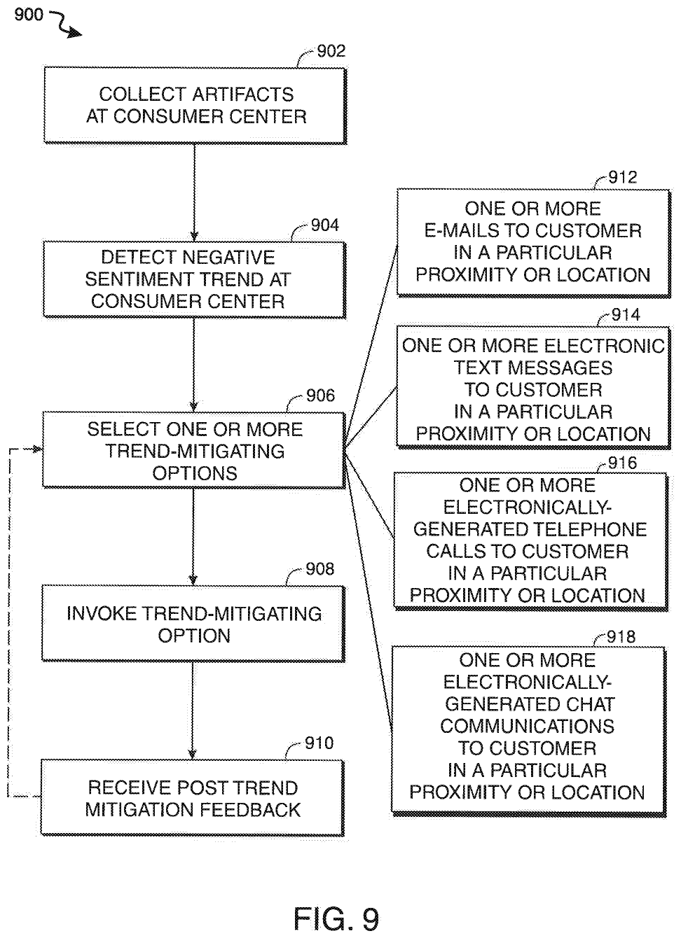

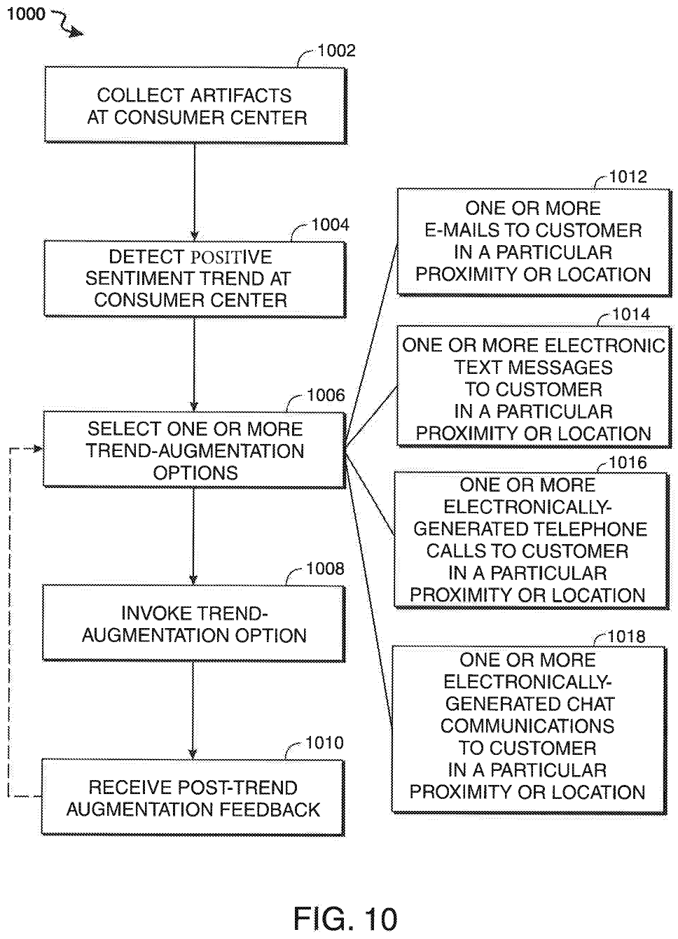

In total, the sentiment shown in center 100 may be considered to be net negative over a pre-determined threshold or trending negative (depending on a sentiment analysis baseline established by the prior history)—i.e., the total sentiment in center 100 is currently negative or trending negative. Either one of these conditions, or both taken together, may establish a condition sufficient to trigger a mitigation response. See, e.g., the portion of the specification set forth below that corresponds to FIGS. 9 and 10.

It should be noted that, in order to provide more sensors may be grouped. Sensors may be grouped based on physical proximity or based on the content (or expected content) of data captured by the sensor. Sensors may be grouped virtually.

Contextually, captured data may provide information not only about the native (physical or virtual) operating environment (or the people located within the environment) surrounding a sensor, but capturing of data from multiple sensors may provide data that signifies occurrence of an event or a harvesting of artifacts in identifying a sentiment trend.

Detecting the occurrence of the event may trigger sensors to take responsive action.

A sensor may include one or more of the following components: I/O circuitry, which may include a transmitter device and a receiver device and may interface with fiber optic cable, coaxial cable, telephone lines, wireless devices, PHY layer hardware, a keypad/display control device or any other suitable encoded media or devices; peripheral devices, which may include counter timers, real-time timers, power-on reset generators or any other suitable peripheral devices; a logical processing device, which may compute data structural information, structural parameters of the data, quantify indices; and machine-readable memory.

Machine-readable memory may be configured to store, in machine-readable data structures: captured data, electronic signatures of biometric features or any other suitable information or data structures. Components of a sensor may be linked by a system bus, wirelessly or by other suitable interconnections. Sensor components may be present on one or more circuit boards. In some embodiments, the components may be integrated into a single chip. The chip may be silicon-based. The sensor may include RAM, ROM, an input/output (“I/O”) module and a non-transitory or non-volatile memory. The I/O module may include a microphone, button and/or touch screen which may accept user-provided input. The I/O module may include one or more of a speaker for providing audio output and a video display for providing textual, audiovisual and/or graphical output.

Software applications may be stored within the non-transitory memory and/or other storage medium. Software applications may provide instructions to the processor that enable a sensor to perform various functions. For example, the non-transitory memory may store software applications used by a sensor, such as an operating system, application programs, and an associated database. Alternatively, some or all of computer executable instructions of a sensor may be embodied in hardware or firmware components of the sensor.

Software application programs, which may be used by a sensor, may include computer executable instructions for invoking user functionality related to communication, such as email, short message service (“SMS”), and voice input and speech recognition applications. Software application programs may utilize one or more algorithms that request alerts, process received executable instructions, perform power management routines or other suitable tasks.

A sensor may support establishing network connections to one or more remote sensors. Such remote sensors may be sensors, actuators or other computing devices. Sensors may be personal computers or servers. A sensor may communicate with other sensors using a data port. The data port may include a network interface or adapter. The communication circuit may include the modem. The data port may include a communication circuit. A sensor may include a modem, antenna or other communication circuitry for establishing communications over a network, such as the Internet. The communication circuit may include the network interface or adapter.

Via the data port and associated communication circuitry, a sensor may access network connections and communication pathways external to the sensor. Illustrative network connections may include a local area network (“LAN”) and a wide area network (“WAN”), and may also include other networks. Illustrative communication pathways may include WiFi, wired connections, Bluetooth, cellular networks, satellite links, radio waves, fiber optic or any other suitable medium for carrying signals.

The existence of any of various well-known protocols such as TCP/IP, Ethernet, FTP, HTTP and the like is presumed, and a sensor can be operated in a client-server configuration to permit a user to retrieve web pages from a web-based server. Web browsers can be used to display and manipulate data on web pages.

Sensors may include various other components, such as a display, battery, speaker, and antennas. Network sensors may be portable devices such as a laptop, tablet, smartphone, other “smart” devices (e.g., watches, eyeglasses, clothing having embedded electronic circuitry) or any other suitable device for receiving, storing, transmitting and/or displaying electronic information. Such sensors may be located on the person of an entity representative in a consumer center.

FIG. 2 shows an illustrative diagram. Artifact mining module, shown at 202, may mine a plurality of artifacts, as shown at 212. The plurality of artifacts may include biometrics 214 (such as body temperature, facial expressions, etc.), telephone conversations 216, verbal statements 220 and/or conversations 222.

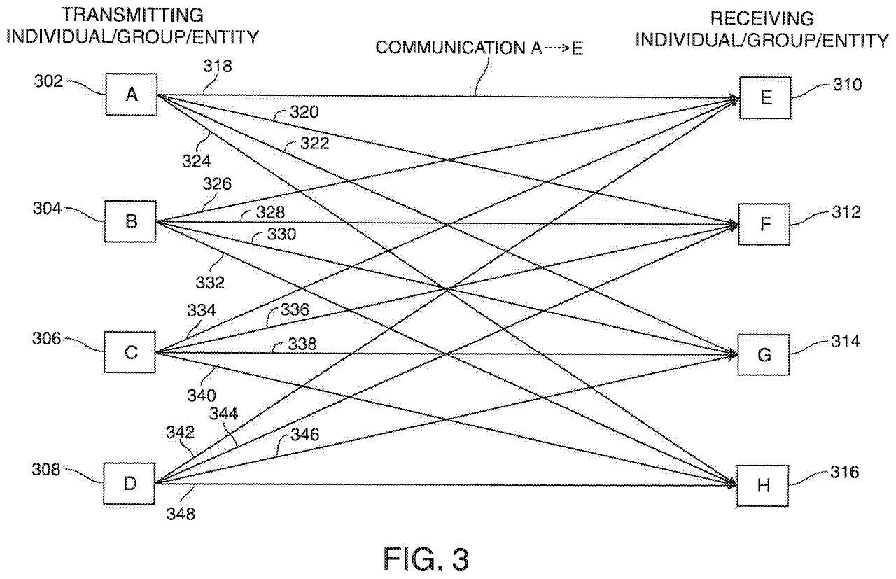

Upon retrieval of one or more artifacts by artifact mining module 202, sentiment analysis scoring module 204 may analyze each of the artifacts. The artifacts may be analyzed based on a variety of different scoring models. The variety of different scoring models may include a polarity-based scoring model, a multi-dimensional vector-based scoring model and a two-dimensional scoring model (see, e.g., the portions of the specification corresponding to FIGS. 3-6). The different scoring models will be described in greater detail below.

The sentiment analysis scoring module may determine a score for each artifact. The score may be a composite score retrieved from numerous scoring models. The score may be a single number score. The score may be a vector.

Upon determination of a score for each of the artifacts, a transmitting entity group and a receiving entity group may be determined for each artifact. It should be appreciated that the score determination may occur prior to, simultaneous to or after the transmitting/receiving entity group determination.

In some embodiments, each artifact may be scored, as shown at 206.

There may be an optional graph that shows communications between persons and/or entities. For example, in a group of 100 entities, 50 of them may be determined to be transmitting entities in such a graph and 50 of them may be determined to be receiving entities in such a graph. The communications between the entities may optionally be shown, for example in a dashboard, as lines across the graph, as shown at 226. More specifically, graph 226 shows the possibility of artifacts mapping various permutations associated with conversations between different people.

In other embodiments, the communication graph may be circular. In such a communication graph, it may be apparent that no specific entity is a transmitting entity and no specific entity is a receiving entity. Each entity can be both a receiving entity and a transmitting entity. Although a horizontal-type graph shows that as well, it becomes clearer in a circular type graph.

After a transmitting entity and a receiving entity are determined, a communication link may be determined. The communication link may link the transmitting entity to the receiving entity. The communication link may be associated with an aggregated score. The aggregated score may be an aggregated sentiment score of all communications between the transmitting entity and the receiving entity. Upon determination of the communication link, the determined score may be added to the aggregated score in order to update the aggregated score. The aggregated score may be updated to reflect the latest artifact. The score may be aggregated, as shown at 208.

It should be appreciated that, at times when there are many artifacts included in the aggregated score, each inputted artifact may change the aggregated score slightly because a single artifact within a plurality of many artifacts only changes the average score slightly. As such if there are only a few artifacts used to create an aggregated score, each inputted artifact may make a significant change in aggregated score.

It should be further appreciated that the score of an artifact being inputted into the aggregated score can be done in multiple approaches. One approach may be that the score is weighted based on the number of artifacts already included in the aggregated score. This way ensures that the score does not have to be averaged each time a new artifact is received. Also, this approach allows the artifacts and their scores to be archived as soon as the artifact is entered into the average.

In another approach, the artifact and its score are maintained and the average is completely re-executed each time a new artifact is received.

Scores may range from healthy and productive environment scores to non-healthy and detrimental environment scores. A healthy and productive environment score may correlate to a positive trend. A non-healthy and detrimental environment score may correlate to a negative trend. Scores that are greater than a predetermined score—i.e., scores that indicate an environment that may be non-healthy and detrimental may be escalated or weighted, as shown at 210. There may be various remediation measures that may be implemented to lower the score for the center (or alternatively, environment). The measures may include halting communications between the entities, redirecting communications between the entities to an intermediary and any other suitable remediation measures.

FIG. 3 shows an illustrative communications map. The illustrative communications map may include a variety of individuals, groups and/or entities. The individuals, groups and/or entities shown include individual/group/entity A (shown at 302), individual/group/entity B (shown at 304), individual/group/entity C (shown at 306), individual/group/entity D (shown at 308), individual/group/entity E (shown at 310), individual/group/entity F (shown at 312), individual/group/entity G (shown at 314) and individual/group/entity H (shown at 316).

Individuals, groups and/or entities A, B, C and D are shown as transmitting individuals, groups and/or entities. Individuals, groups and/or entities E, F, G and H are shown as receiving individuals, groups and/or entities. In some embodiments, an individual, group and/or entity may be defined as a transmitting individual, group and/or entity or a receiving individual, group and/or entity. In certain embodiments, an individual, group and/or entity may be considered both a transmitting individual, group and/or entity and a receiving individual, group and/or entity.

Each individual, group and/or entity may be in communication with one or more of the other individuals, groups and/or entities. The communications may be conducted over communication lines. The communication lines may be actual communication lines (such as a real conversation between two people), virtual communication lines, wired communication lines, wireless communication lines, communication lines that utilize a network or any other suitable communication lines.

Each communication line shown may connect two or more individuals, groups and/or entities. It should be appreciated that, although the communication lines shown connect A, B, C and D to E, F, G and H, there may be additional communication lines that are not shown. In some embodiments, communication lines may enable communication between A, B, C and D, and between E, F, G and H.

Each communication line may enable one-way or two-way communications. Communication lines that enable two-way communications may conduct communication from a first individual, group or entity to a second individual, group or entity, and from the second individual, group or entity to the first individual, group or entity. Communication lines that are one-way may be parallel to a second communication line that enables the reverse of the one-way communication line. For example, if a first communication line enables one-way communication between entity group A and entity group E, a parallel communication line may enable one-way communication between entity group E and entity group A.

Communication lines shown may include 318 (A-E), 320 (A-F), 322 (A-G), 324 (A-H), 326 (B-E), 328 (B-F), 330 (B-G), 332 (B-H), 334 (C-E), 336 (C-F), 338 (C-G), 340 (C-H), 342 (D-E), 344 (D-F), 346 (D-G) and 348 (D-H).

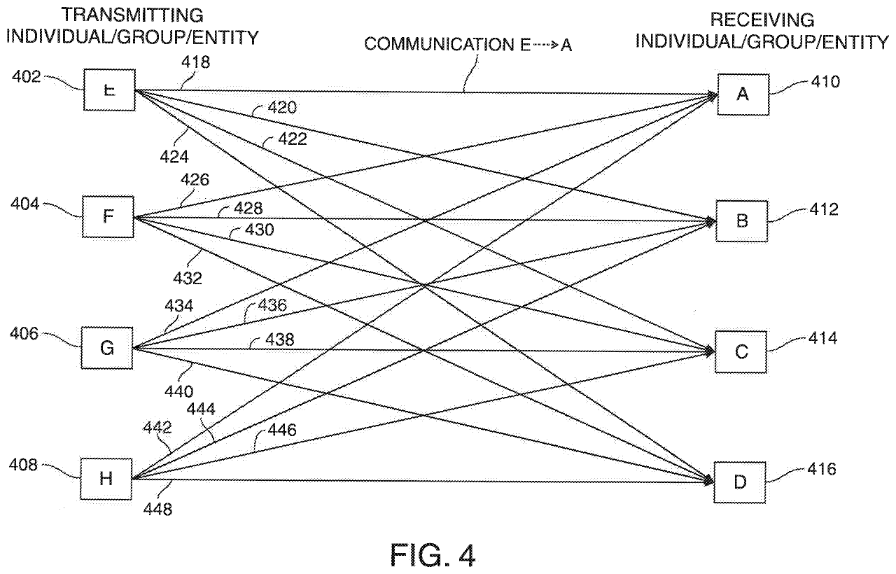

FIG. 4 shows another illustrative communications map. The communications map may show individual, group or entity E (shown at 402), individual, group or entity F (shown at 404), individual, group or entity G (shown at 406) and individual, group or entity H (shown at 408) communicating with individual, group or entity A (shown at 410), individual, group or entity B (shown at 412), individual, group or entity C (shown at 414) and individual, group or entity D (shown at 416).

Each communication line shown may connect two or more entity groups. It should be appreciated that, although the communication lines shown connect individuals, groups or entities E, F, G and H to individuals, groups or entities A, B, C and D, there may be additional communication lines that are not shown. In some embodiments, communication lines may enable communication between individuals, groups or entities E, F, G and H, and between individuals, groups or entities A, B, C and D.

Each communication line may enable one-way or two-way communications. Communication lines that enable one-way communication may push communications from a first individual, group or entity to a second individual, group or entity. Communication lines that enable two-way communications may push communication from a first individual, group or entity to a second individual, group or entity, and from the second individual, group or entity to the first individual, group or entity. Communication lines that are one-way may be parallel to a second communication line that enables the reverse of the one-way communication line. For example, if a first communication line enables one-way communication between individual, group or entity A and individual, group or entity E, a parallel communication line may enable one-way communication between individual, group or entity E and individual, group or entity A.

Communication lines shown may include 418 (E-A), 420 (E-B), 422 (E-C), 424 (E-D), 426 (F-A), 428 (F-B), 430 (F-C), 432 (F-D), 434 (G-A), 436 (G-B), 438 (G-C), 440 (G-D), 442 (H-A), 444 (H-B), 446 (H-C) and 448 (H-D).

FIG. 5 shows an illustrative scoring scale. There may be various different methods or scales for scoring artifacts as part of an aggregate score. For example, an artifact may be scored based on positive or negative sentiment. An artifact may be scored based on polar emotions, such as happy or sad. An artifact may be scored in a non-polar scale, such as a vector scaling model. An artifact may be scored on a collection of multiple sentiment scoring methods or models. It should be noted that, as shown above with respect to the portion of the specification corresponding to FIG. 1, the artifacts may retrieve information regarding consumers currently located in a consumer center.

Polarity-based scoring scale 502 is shown in FIG. 5. In such a scoring scale, each artifact is scored on a polar scale using linguistic scoring methodology. Such methodology may be most useful in scoring conversations and written information. It should be noted, however, that sentiment analysis, according to the disclosure, may also be applied to biometric information such as body temperature, facial expression, vocal pitch and/or tone, etc.

Linguistic scoring methodology may utilize various language scoring methods, such as natural language processing, computational linguistics and biometrics. The language scoring methodology may also include text analysis. The text analysis may analyze various components of the text. It should be appreciated that, to a human reader, certain text components, such as sarcasm, exaggerations or jokes may be easily understood. However, a computer may require special methods to ensure that such linguistic terms are not misinterpreted. Therefore, the text analysis may analyze key words and phrases, emoticons, characters, length of response, response time between artifacts, related artifacts, negation, exaggeration, jokes and sarcasm. Based on the linguistic scoring methodology, each artifact may be scored on a scale of 0% to 100%, as shown at 504 and 506. 0% may indicate most positive and 100% may indicate most negative. As mentioned above, however, such a scoring methodology may also be adapted and used for non-verbal and non-linguistic biometric information.

It should be appreciated that a polarity-based scale may include two opposite emotions, whether positive and negative, happy and sad or any other suitable opposite emotions. Therefore, each artifact scored on a polarity-based score may only be given a score based on the polarity of the artifact. However, at times, in order to compensate for the shortcomings of the polarity-based scoring models, an artifact may be scored on multiple polarity-based scoring models, and, the results of the scoring models may be combined.

FIG. 6 shows a multi-dimensional scoring scale. The multi-dimensional scoring scale may include a plurality of vectors. Each of the vectors may correspond to a different emotion or sentiment. The emotions, or sentiments shown, may include positive (602), encouraged (604), satisfied (606), happy (608), calm (610), assurance (612), unintelligent (614), prevented (616), negative (618), aggravated (620), frustrated (622), sad (624), anger (626), fear (628), intelligent (630) and promoted (632).

Vector 634 may be a vector generated from an artifact. The artifact may include a plurality of attributes. The artifact may be broken down into component parts. The attributes and the component parts may be used to plot the artifact on the multi-dimensional scoring scale.

The sentiment of the artifact plotted as vector 634 may be shown in-between intelligent and promoted. It should be appreciated that the multi-dimensional scoring scale may be used to determine the sentiment of an artifact. The multi-dimensional scoring scale may include a plurality of other emotions, not shown. In some embodiments, the multi-dimensional scoring scale may utilize any suitable emotion chart.

FIG. 7 shows another multi-dimensional scoring scale. The multi-dimensional scoring scale may be three-dimensional. The three-dimensional scoring scale may include an x-dimension (horizontal), a y-dimension (vertical) and a z-dimension (depth). Vectors that represent emotions may be plotted on the three-dimensional scoring scale.

A vector may have multiple dimensions, such as an x-dimension, a y-dimension and a z-dimension. As such, a vector may be plotted on the three-dimensional scoring scale that comprises an x-dimension, y-dimension and z-dimension. Each plotted emotion may be represented by a vector, such as vector 702 that represents emotion 1, vector 704 that represents emotion 2, vector 706 that represents emotion 3 and vector 708 that represents emotion 4.

Build of a vector, or orientation of a vector, could be based on one or more of a combination of sentiments or emotions. In some embodiments, vector length could correspond to magnitude or intensity of a vector.

Each plotted vector that represents an emotion may have two extremes. For example, a vector may represent a range of happiness and sadness. Each point of the vector may represent a different extreme in the range of happiness and sadness. At the (0,0,0) point, the vector may represent neutrality (neither happy nor sad). Location points found on the vector above the (0,0,0) point may represent a gradually increasing degree of happiness, while location points found below the (0,0,0) point may represent a gradually increasing degree of sadness.

Upon the receipt of an unlabeled artifact, the artifact may be broken down into component parts. The component parts may be used to generate a vector. The vector may be plotted on a multi-dimensional scoring scale, such as the one shown in FIG. 7. Such a vector may be shown at 710. Vector 710 may represent the sentiment of emotion 1. Because sentiment of an artifact may be multi-faceted—i.e., may include multiple emotions—vector 710 may represent the sentiment of emotion 1 with respect to the emotion vectors.

In some embodiments, the emotion vector, or vectors, that most closely represents the sentiment of the artifact may be displayed to a user. In certain embodiments, a detailed score comprising the various components of the artifact may be shown. For example, an artifact may be determined to include 20% happiness, 40% kindness, 30% caring and 10% consideration. For such an artifact, the entire breakdown may be shown and/or the single most dominant attribute—kindness may be shown. In some embodiments, the only displayed sentiment may be positive or negative.

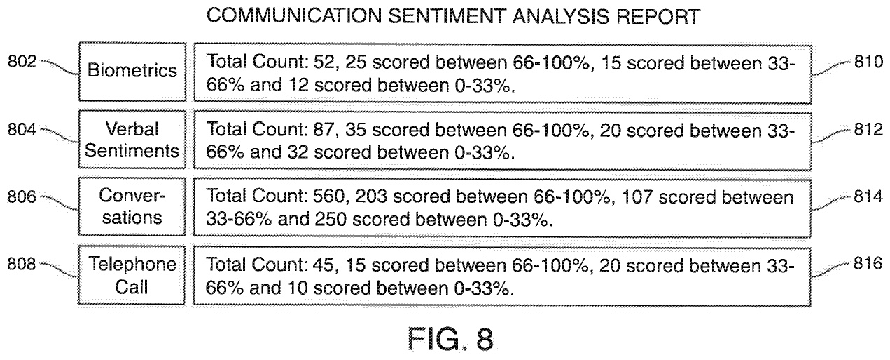

FIG. 8 shows an exemplary sentiment analysis report. The exemplary sentiment analysis report may be for communications between entities A and E. In the sentiment analysis report shown, the various categories of communications may be analyzed separately. The categories shown may include letters (802), IMS (804), chat (806), email (808), SMS (810) and phone call (812). The analysis for each of the categories may be shown at 814 (letter analysis), 816 (IMS analysis), 818 (chat analysis), 820 (email analysis), 822 (SMS analysis) and 824 (phone call analysis). It should be appreciated that the analysis shown in FIG. 8 may be based on a polarity-based scoring model, however, any suitable scoring model may be used to generate an analysis.

In some embodiments, different communication types may be weighted differently—i.e., not all communications may carry the same weight.

Such a sentiment analysis report may be useful in determining which category of communication is most effective between two individuals, groups and/or entities. Specifically, if one communication mode is more effective than another communication mode—i.e., a first communication mode is determined to include significantly more positive communications than a second communication mode—appropriate remediation measures may be instituted to encourage the use of the more effective communication mode.

FIG. 9 shows a first illustrative flow diagram 900 for detecting a negative trend and responding thereto. First illustrative flow diagram 900 may utilize a public API or other device to collect artifacts, as shown at 902.

Based on this information, first illustrative flow diagram 900 may detect a negative sentiment trend, as shown at 904. It should be noted that this detection may occur at the dashboard level, or using a dashboard. In any case, flow 900 may exist with or without dashboard utilization.

At step 906, flow 900 may include auto-selecting, in response to detection of a negative sentiment trend at 904, one or more trend-mitigating options. Such selection may be based on machine learning (ML) that is based on the success or failure of historical trend mitigating options. Furthermore, such selection can be tuned, as set forth in more detail below with regards to the portion of the specification relating to post trend mitigation feedback 910.

Such trend-mitigating options may include transmission of one or more e-mails (to relevant parties) 912, transmission of one or more electronic-text messages (to relevant parties) 914, transmission of one or more electronically-generated telephone calls (to relevant parties) 916 and transmission of one or more electronically-generated chat communications (to relevant parties) 918. Such transmission, w/ trend-mitigating messaging, may serve to offset other trend-causing stimuli.

Thereafter, flow 900 may include invoking trend-mitigating option 908. Following invocation of trend-mitigating option 908, flow 900 may include receiving post trend mitigation feedback, as shown at 910. Such feedback 910 may be used to select one or more additional trend-mitigating options as shown at 906 in an additional round(s) of trend mitigation. It should be noted that ML may be used to select which option should be used to further mitigate. For example, trend-mitigating text-messaging may be invoked when an immediate trend-mitigation response is called for.

FIG. 10 shows a flow diagram similar to the flow diagram shown in FIG. 9. The difference between flow 1000 shown in FIG. 10 and flow 900 shown in FIG. 9 is that flow 1000 is for augmenting positive trending sentiment, while flow 900 is for mitigating the effects of negative-trending sentiment. It should be noted, however, that steps 1002, 1004, 1006, 1008 and 1010 substantially mirror steps 902, 904, 906, 908 and 910 albeit in the augmentation of positive-trending sentiment instead of mitigating negative-trending sentiment. It should also be noted that exemplary augmentation options 1012, 1014, 1016 and 1018 substantially mirror mitigation options 912, 914 and 916. It should be noted, however, that the methods for mitigating negative trends may be the same or different from the methods for augmenting positive trends.

FIG. 10 shows a first illustrative flow diagram 1000 for detecting a positive trend and responding thereto. First illustrative flow diagram 1000 may utilize a public API or other device to collect artifacts, as shown at 1002.

Based on this information, first illustrative flow diagram 1000 may detect a positive sentiment trend, as shown at 1004. It should be noted that this detection may occur at the dashboard level, or using a dashboard. In any case, flow 1000 may exist with or without dashboard utilization.

At step 1006, flow 1000 may include auto-selecting, in response to detection of a positive sentiment trend at 1004, one or more trend-mitigating options. Such selection may be based on machine learning (ML) that is based on the success or failure of historical trend mitigating options. Furthermore, such selection can be tuned, as set forth in more detail below with regards to the portion of the specification relating to post trend mitigation feedback 1010.

Such trend-mitigating options may include transmission of one or more e-mails (to relevant parties) 1012, transmission of one or more electronic-text messages (to relevant parties) 1014, transmission of one or more electronically-generated telephone calls (to relevant parties) 1016 and transmission of one or more electronically-generated chat communications (to relevant parties) 1018. Such transmission, w/ trend-mitigating messaging, may serve to offset other trend-causing stimuli.

Thereafter, flow 1000 may include invoking trend-mitigating option 1008. Following invocation of trend-mitigating option 1008, flow 1000 may include receiving post trend mitigation feedback, as shown at 1010. Such feedback 1010 may be used to select one or more additional trend-mitigating options as shown at 1006 in an additional round(s) of trend mitigation. It should be noted that ML may be used to select which option should be used to further mitigate. For example, trend-mitigating text-messaging may be invoked when an immediate trend-mitigation response is called for.

Thus, an aggregated sentiment analysis system for providing an electronic dashboard for dynamically monitoring sentiment based on, inter alia, social media data and triggering mitigating efforts, in response thereto, or triggering trend augmentation efforts in response to the detection of positive trends, is provided. Persons skilled in the art will appreciate that the present invention can be practiced by other than the described embodiments, which are presented for purposes of illustration rather than of limitation. The present invention is limited only by the claims that follow.

What is claimed is:

1. A method for identifying and mitigating a negative sentiment trend, the sentiment trend being derived from a sentiment analysis, the sentiment analysis being based on aggregating a plurality of biometric information artifacts obtained from a gathering of a plurality of consumers in a consumer center, the consumer center being located in a confined space, the method comprising:
harvesting the artifacts from the plurality of consumers, the harvesting comprising capturing artifacts using one or more thermal cameras to determine a body temperature of the plurality of consumers;
based on the harvesting, identifying a biometric information trend comprising a body temperature trend recorded from among the plurality of consumers;
periodically updating, over a pre-determined amount of time, the determining the body temperature of the plurality of consumers, the periodically updating used to update the biometric information trend;
determining, over the pre-determined amount of time, that the biometric information trend is a negative biometric information trend; and
triggering, based at least in part on a slope of the negative biometric information trend, a mitigating response to the negative biometric information trend.

2. The method of claim 1 wherein the mitigating response is selected from a group consisting of one or more e-mail communications to a selected group of consumers associated with an entity controlling the consumer center, one or more electronic text messaging communications to the selected group of consumers associated with the entity, one or more electronically-generated telephone communications to the selected group of consumers associated with the entity, one or more electronically-generated chat communications to the selected group of consumers associated with the entity and a combinations thereof.

3. The method of claim 1 wherein the mitigating response is triggered in real-time following the determining of the negative biometric information trend.

4. The method of claim 1 wherein the harvesting further comprises using one or more thermal cameras to identify physical movements associated with the plurality of consumers.

5. The method of claim 1 wherein the harvesting further comprises retrieving verbal communications from the plurality of consumers, and parsing, using natural language processing and computational linguistics, the retrieved verbal communications to contribute to the harvesting.

6. The method of claim 1 wherein the harvesting the biometric information trend further comprises harvesting while maintaining anonymous a plurality of identities associated with the plurality of the consumers.

7. The method of claim 1 wherein the harvesting the artifacts further comprises using one or more thermal cameras to identify facial expressions associated with the plurality of consumers.

8. A method for identifying and mitigating a negative sentiment trend, said sentiment trend being derived from a sentiment analysis, the sentiment analysis being based on aggregating a plurality of biometric information artifacts obtained from a gathering of a plurality of consumers in a consumer center, said consumer center being located in a confined space, the method comprising:
harvesting the artifacts from the plurality of consumers, the harvesting comprising capturing the artifacts by using one or more thermal cameras to determine a plurality of physical movements of the plurality of consumers;
based on the harvesting, identifying a biometric information trend, the biometric information trend comprising a physical movement trend recorded from among the plurality of consumers;
periodically updating, over a pre-determined amount of time, the harvesting, said periodically updating used to update the artifacts;
determining, over the pre-determined amount of time, that the biometric information trend is a negative biometric information trend; and
triggering, based at least in part on a slope of the negative biometric information trend, a mitigating response to the negative biometric information trend.

9. The method of claim 8 wherein the mitigating response is selected from a group consisting of one or more e-mail communications to a selected group of consumers associated with an entity controlling the consumer center, one or more electronic text messaging communications to the selected group of consumers associated with the entity, one or more electronically-generated telephone communications to the selected group of consumers associated with the entity, one or more electronically-generated chat communications to the selected group of consumers associated with the entity.

10. The method of claim 8 wherein the mitigating response is triggered in real-time following the determining of the negative biometric information trend.

11. The method of claim 8 wherein the harvesting comprises using the one or more thermal cameras to determine body temperature for each of the plurality of consumers.

12. The method of claim 8 wherein the harvesting further comprises retrieving verbal communications from the plurality of consumers, and parsing, using natural language processing and computational linguistics, the retrieved verbal communications to contribute to the harvesting.

13. The method of claim 8 wherein the harvesting further comprises harvesting the artifacts independent of a determination of identities of each of the plurality of the consumers.

14. The method of claim 8 wherein the harvesting further comprises using one or more thermal cameras to identify facial expressions associated with the plurality of consumers.

15. A method for identifying and mitigating a negative sentiment trend, said sentiment trend being derived from a sentiment analysis, the sentiment analysis being based on aggregating a plurality of information artifacts obtained from a gathering of a plurality of consumers in a consumer center, said consumer center being located in a confined space, the method comprising:
harvesting the artifacts from the plurality of consumers, the artifacts comprising a set of verbal communications;
based on the harvesting, identifying an information trend, the harvesting comprising capturing the information trend by using one or more microphones to record the set of verbal communications;
periodically updating, over a pre-determined amount of time, the harvesting, said periodically updating used to update the information trend;
determining, over the pre-determined amount of time, that the information trend is a negative information trend; and
triggering, based at least in part on a slope of the negative information trend, a mitigating response to the negative information trend.

16. The method of claim 15 wherein the mitigating response is selected from a group consisting of one or more e-mail communications to a selected group of consumers associated with an entity controlling the consumer center, one or more electronic text messaging communications to the selected group of consumers associated with the entity, one or more electronically-generated telephone communications to the selected group of consumers associated with the entity, one or more electronically-generated chat communications to the selected group of consumers associated with the entity.

17. The method of claim 15 wherein the mitigating response is triggered in real-time following the determining of the negative information trend.

18. The method of claim 15 wherein the harvesting further comprises using a thermal camera to identify physical movements associated the plurality of consumers.

19. The method of claim 15 wherein the harvesting the information trend further comprises harvesting independent of a determination of identities of each of the plurality of the consumers.

20. The method of claim 15 wherein the harvesting further comprises using a thermal camera to identify facial expressions associated with the plurality of consumers.
